(19) United States
(12) Patent Application Publication
(10) Pub. No.: US 2012/0256412 A1
(43) Pub. Date: Oct. 11, 2012

(54) Joint member manufactured using pipe and manufacturing method of the same

(76) Inventor: Seung Oh, Seoul (KR)

(21) Appl. No.: 13/064,694

(22) Filed: Apr. 8, 2011

(51) Int. Cl. F16L 41/00; B23P 17/00

(52) U.S. Cl. 285/192; 29/527.1

(57) ABSTRACT

Disclosed therein is a joint member, which includes a retaining portion formed by pressing a stainless steel pipe that is cut into a predetermined length, a joining portion having a spiral portion or a spiral groove, and an insert member made of synthetic resin and being pressed into the pipe so that a packing and a compression ring can be located in a proper position. The joint member using a pipe includes: a metal member having a retaining portion formed by pressing a stainless steel pipe cut into a predetermined length and a joining portion formed on the stainless steel pipe; and an insert member made of synthetic resin, the insert member being pressed to the retaining portion and mounted on the inner circumference of the metal member to locate joint means in a proper position.

### BACKGROUND OF THE INVENTION

1. Field of the Invention

The present invention relates to a joint member manufactured using a pipe and a manufacturing method of the same, and more particularly, to a joint member that is manufactured using a stainless steel pipe in various forms by pressing work and insert press-in work without needing a hazard inspection due to lead hazards.

2. Background Art

In general, a joint member for corrugated pipes or straight pipes has a spiral portion formed on the outer circumferential surface thereof or a spiral groove formed on a through hole, and the through hole has a stepped jaw or an inclined jaw portion, to which joint means having a packing and a compression ring can be mounted in a proper position.

Moreover, a member that has a spiral groove formed on the inner circumference of a pipe is used at a connection portion of the joint member, which is welded integrally with various tools, and, to which the corrugated pipe or the straight pipe is connected. However, because the member does not have the stepped jaw or the inclined jaw portion and the joint means including the packing and the compression ring cannot be mounted thereon, the joint member is additionally joined to the connection portion, and then, the corrugated pipe or the straight pipe is connected to the joint member.

Typically, such a joint member is manufactured of brass casting, but recently, tends to be manufactured of stainless material due to controversy of lead hazards.

However, in case that the stainless material, which does not cause the controversy of lead hazards, in order to form the stepped jaw or the inclined jaw portion on the through hole, the joint member must be manufactured through a precise casting method, but it causes an increase of manufacturing costs and a productivity loss. Accordingly, manufacturers, who work in the art, are in dilemma.

### SUMMARY OF THE INVENTION

Accordingly, the present invention has been made to solve the above-mentioned problems occurring in the prior arts, and it is an object of the present invention to provide a joint member, which includes a retaining portion formed by pressing a stainless steel pipe that is cut into a predetermined length, a joining portion having a spiral portion or a spiral groove, and an insert member made of synthetic resin and being pressed into the pipe so that a packing and a compression ring can be located in a proper position.

In the present invention, the joint member may be a bolt or a nut, which is a component of joint means used for connecting a corrugated pipe or a straight pipe, or a connection portion that is welded integrally to a machine, such as a distributor for a boiler, to which the corrugated pipe or the straight pipe is connected.

To accomplish the above object, according to the present invention, there is provided a joint member including: a metal member having a retaining portion formed by pressing a stainless steel pipe cut into a predetermined length and a joining portion formed on the stainless steel pipe; and an insert member made of synthetic resin, the insert member being pressed to the retaining portion and mounted on the inner circumference of the metal member to locate joint means in a proper position.

Moreover, a nut portion is formed on the outer circumference of the metal member, which is the stainless steel pipe, by pressing work, so that a corrugated pipe or a straight pipe can be joined easily.

In another aspect of the present invention, there is provided a method of manufacturing a joint member using a pipe including: a press-molding process of manufacturing a metal member of half-finished goods by pressing a stainless steel pipe, which is cut into a predetermined length, to form a retaining portion; a screw forming process of forming a joining portion on the metal member of the half-finished goods; and an insert press-in process of pressing an insert member, which is made of synthetic resin material, to the retaining portion.

Furthermore, the press-molding process includes a first press-molding process of molding the retaining portion (11); and a second press-molding process of molding a nut portion (13) on the outer circumference of the pipe.

As described above, the present invention can manufacture joint members for various use purposes using a stainless steel pipe only by pressing work and insert press-in work, whereby joint members, which can calm the controversy of lead hazards, can be effectively manufactured.

### BRIEF DESCRIPTION OF THE DRAWINGS

The above and other objects, features and advantages of the present invention will be apparent from the following detailed description of the preferred embodiments of the invention in conjunction with the accompanying drawings, in which:

FIGS. 1a, 1b and 1c are views showing a manufacturing process of a joint member according to the present invention;

FIG. 2 is a perspective view showing an example that the joint member according to the present invention is mounted on connection portions (see FIG. 1a) of various machines;

FIG. 3 is a sectional view of FIG. 2;

FIG. 4 is a perspective view showing an example that the joint member according to the present invention is a nut (see FIG. 1b);

FIG. 5 is a sectional view of FIG. 4;

FIG. 6 is a perspective view showing an example that the joint member according to the present invention is a bolt (see FIG. 1c);

FIGS. 7a and 7b are sectional views showing examples of a joining portion of FIG. 6; and

FIG. 8 is a perspective view, in a partial section, showing a state where a corrugated pipe is connected using the joint member according to the present invention.

### DETAILED DESCRIPTION OF THE PREFERRED EMBODIMENT

Reference will be now made in detail to the preferred embodiment of the present invention with reference to the attached drawings.

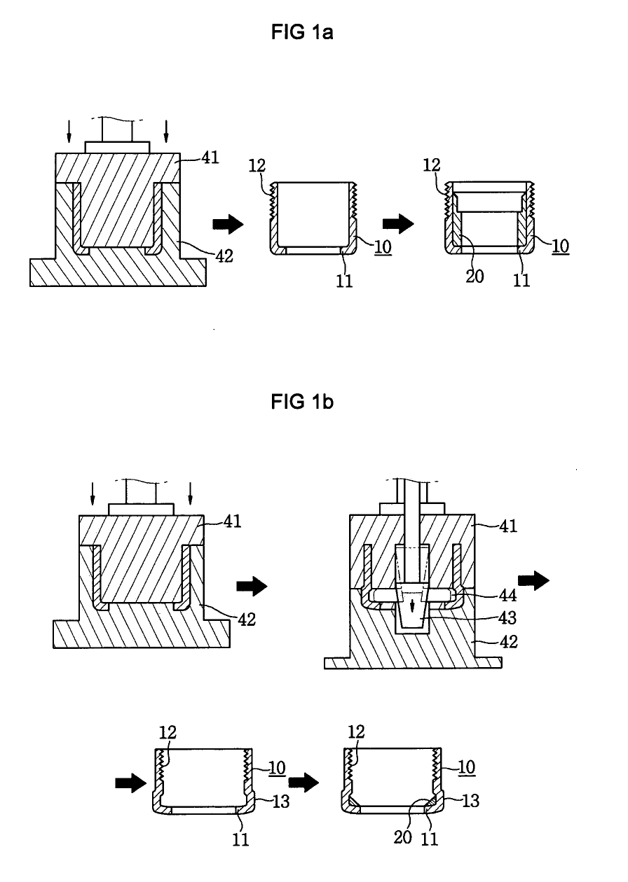

FIGS. 1a, 1b and 1c are views showing a manufacturing process of a joint member according to the present invention. As shown in the drawings, the manufacturing process of the joint member according to the present invention includes: a press-molding process of manufacturing a metal member 10 of half-finished goods by pressing a stainless steel pipe, which is cut into a predetermined length, to form a retaining portion 11; a screw forming process of forming a joining portion 12 on the metal member 10 of the half-finished goods; and an insert press-in process of pressing an insert member 20, which is made of synthetic resin material, to the retaining portion 11.

FIG. 1a illustrates a state where a connection portion welded integrally to a machine, such as a distributor 30, is manufactured as the joint member of the present invention.

Referring to FIGS. 1b and 1c, the press-molding process includes a first press-molding process of molding the retaining portion 11; and a second press-molding process of molding a nut portion 13 formed on the outer circumference of the pipe. In the drawings, the joint member according to the present invention is manufactured as a nut or a bolt for a connection device having the nut portion 13 on the outer face thereof.

Molds 41 and 42 that are used for the press-molding process may be a well-known press device having a shape corresponding to the shape of the metal member 10 to be manufactured.

A mold 42 that is used for the second press-molding process may be a press device that includes at least two split stretchers 43 forming a hexagonal shape and being located inside the press device and a press-in tool 44 for extruding out while the stretchers 43 goes down.

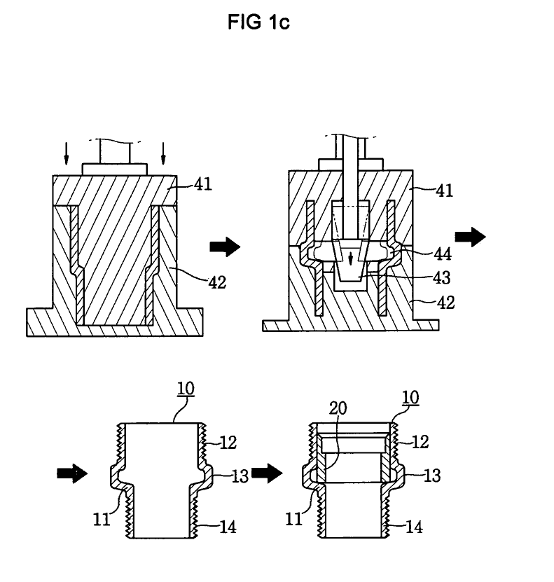

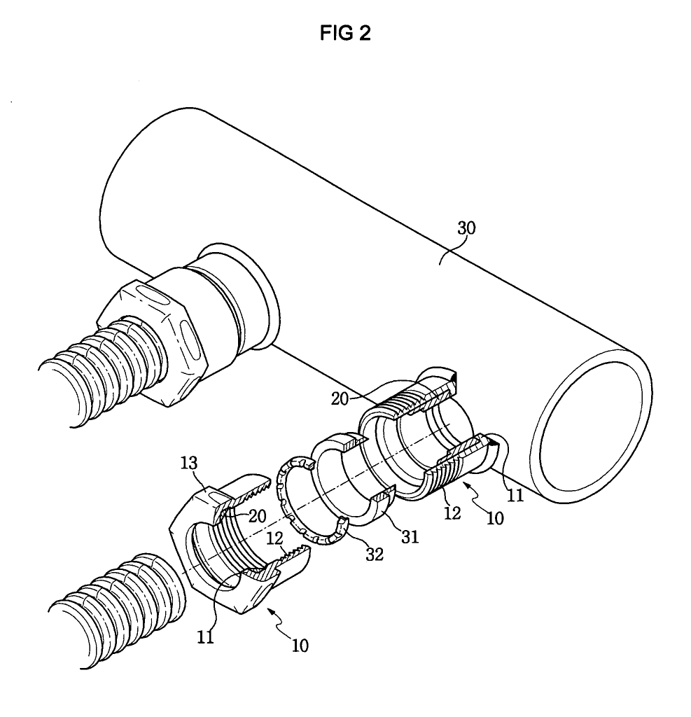

FIGS. 2 and 3 illustrate an example that the connection portion welded integrally to the machine, such as the distributor 30, is manufactured as the joint member according to the present invention. Because the retaining portion 11 is welded integrally to the distributor 30, the connection portion serves as the joint member, on which a packing 31 and a compression ring 32 can be mounted by the insert member 20. In this instance, the joining portion 12 is formed on the outer circumference of the connection portion of the joint member.

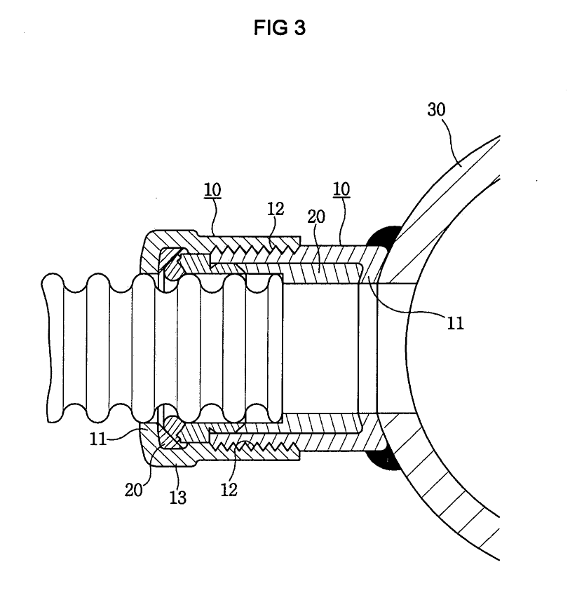

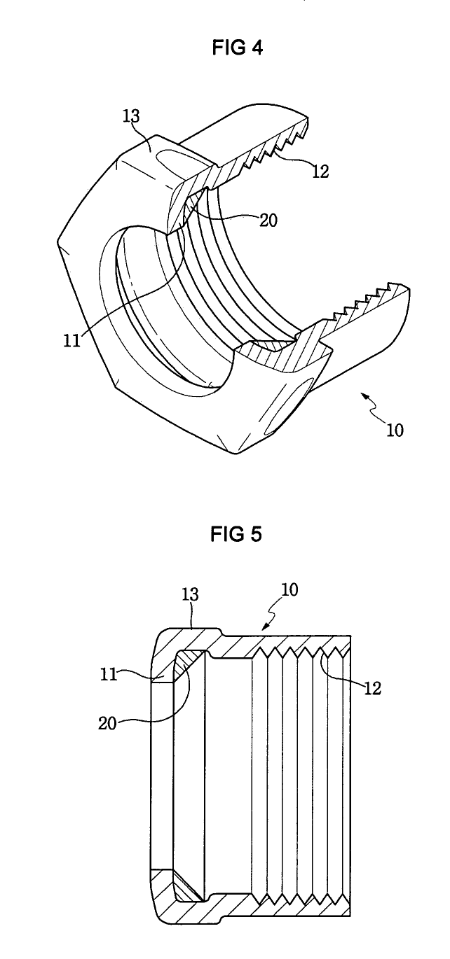

FIGS. 4 and 5 illustrate an example that the joint member having the nut portion 13 formed by the second press-molding process is manufactured as a nut, and in this instance, the joining portion 12 is a spiral groove.

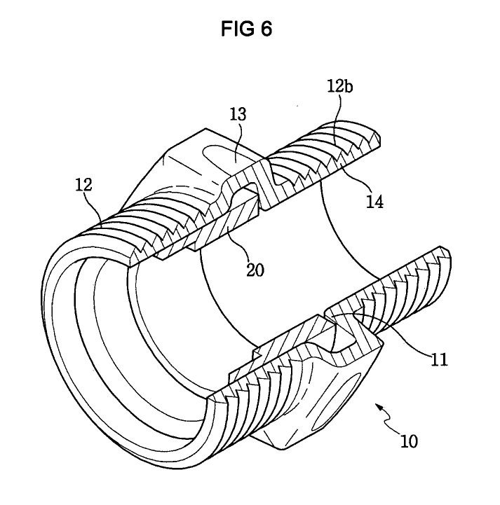

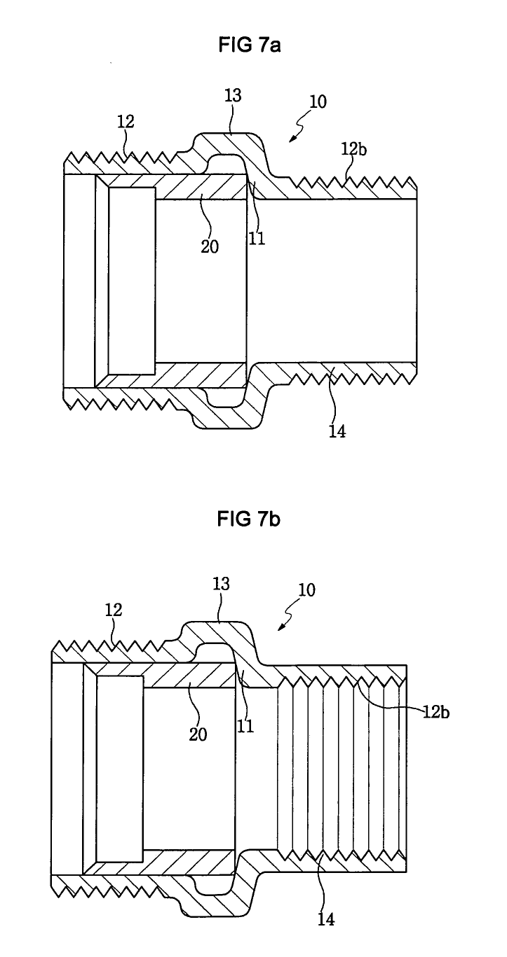

FIGS. 6 and 7a and 7b illustrate an example that the joint member having the nut portion 13 formed by the second press-molding process is manufactured as a bolt, and in this instance, the joint member has a small diameter portion 14 extending from the nut portion 13 in the first press-molding process. In this instance, the joining portion 12 formed on the metal member 10 having the small diameter portion 14 may selectively have a spiral groove 12a or a spiral portion 12b according to kinds of the bolt, which is the joint member.

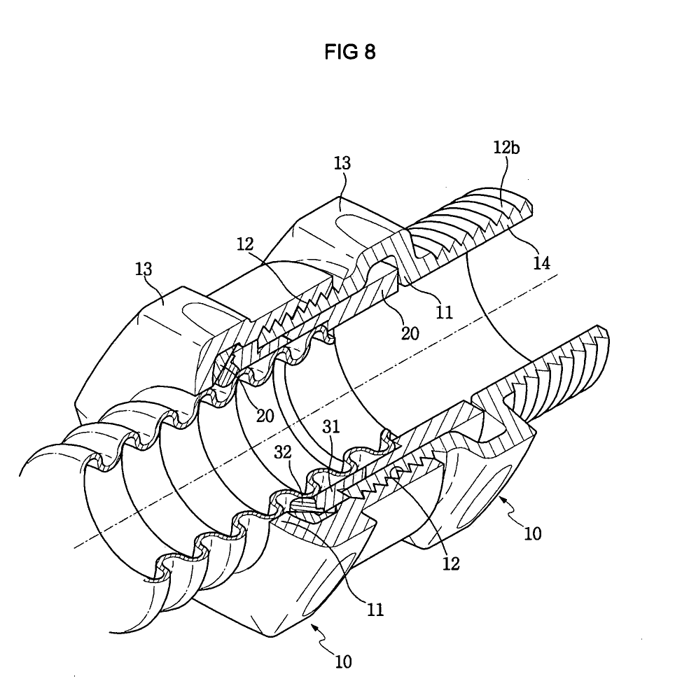

FIG. 8 is a perspective view, in a partial section, showing a state where a corrugated pipe is connected using the nut and the bolt illustrated in FIGS. 4 to 7a, which are the joint members manufactured according to the present invention.

As described above, when joint means including the packing 31 and the compression ring 32 is mounted at a predetermined position by the insert member 20, a corrugated pipe or a straight pipe can be connected and mounted with sealability. The joint means may have one of various structures besides the above, and the insert member 20 is manufactured according to the structure of the joint means.

The joint member according to the present invention, which is manufactured as the nut or the bolt, to the connection portion of various machines includes: a metal member 10 having a retaining portion 11 formed by pressing a stainless steel pipe cut into a predetermined length and a joining portion 12 formed on the stainless steel pipe; and an insert member 20 made of synthetic resin, the insert member 20 being pressed to the retaining portion 11 and mounted on the inner circumference of the metal member 10 to locate joint means in a proper position.

As shown in FIG. 4, in case of the joint member used as the nut, the metal member 10, which is a stainless steel pipe, further includes a nut 13 having a hexagonal appearance and being formed on the outer circumference of the metal member 10 by the pressing work. Moreover, as shown in FIG. 6, in case of the joint member used as the bolt, the metal member 10 is press-molded to have a small diameter portion 14 extending from the nut portion 13.

As shown in FIGS. 2 to 6, the joining portion 12 may be the spiral portion formed on the outer circumference of the metal member 10 or the spiral groove formed on the inner circumference of the metal member 10 according to kinds of the joint member.

As described above, the joint member according to the present invention, which can calm controversy of lead hazards, can be easily manufactured only by the manufacturing method including the steps of manufacturing the metal member of half-finished goods through a pressing process using the stainless steel pipe, finishing the metal member 10 by forming the joining portion thereon; and pressing the insert member 20 made of synthetic resin into the metal member 10 to locate the joint means in a proper position.

While the present invention has been described with reference to the particular illustrative embodiments illustrated in the attached drawings, it is not to be restricted by the embodiments but only by the appended claims. It is to be appreciated that those skilled in the art can change or modify the embodiment without departing from the scope and spirit of the present invention.

What is claimed is:

1. A joint member comprising:
a metal member (10) having a retaining portion (11) formed by pressing a stainless steel pipe cut into a predetermined length and a joining portion (12) formed on the stainless steel pipe; and
an insert member (20) made of synthetic resin, the insert member (20) being pressed to the retaining portion (11) and mounted on the inner circumference of the metal member (10) to locate joint means in a proper position.

2. The joint member according to claim 1, wherein the joining portion (12) is formed on the outer circumference of the metal member (10) and the retaining portion (11) is welded integrally with a machine to form a connection portion.

3. The joint member according to claim 1, wherein the metal member 10 comprises a nut (13) having a hexagonal appearance and being formed on the outer circumference of the metal member (10) by press-molding work.

4. The joint member according to claim 3, wherein the metal member (10) further comprises a small diameter portion (14) extendedly formed on the nut portion (13) when the retaining portion (11) is press-molded.

5. A method of manufacturing a joint member using a pipe comprising:
a press-molding process of manufacturing a metal member (10) of half-finished goods by pressing a stainless steel pipe, which is cut into a predetermined length, to form a retaining portion (11); a screw forming process of forming a joining portion (12) on the metal member (10) of the half-finished goods; and an insert press-in process of pressing an insert member (20), which is made of synthetic resin material, to the retaining portion (11).

6. The manufacturing method according to claim 5, wherein the press-molding process includes a first press-molding process of molding the retaining portion (11); and a second press-molding process of molding a nut portion (13) on the outer circumference of the pipe.

7. The manufacturing method according to claim 5, wherein in the first pressing process, a small diameter portion (14) is extendedly formed on the nut portion (13).
